(19) United States
(12) Patent Application Publication
(10) Pub. No.: US 2015/0026147 A1
(43) Pub. Date: Jan. 22, 2015

(54) METHOD AND SYSTEM FOR SEARCHES OF DIGITAL CONTENT

(71) Applicant: Vidispine AB, Kista (SE)

(72) Inventors: Isak Jonsson, Uppsala (SE); Erik Åhlin, Sollentuna (SE)

(21) Appl. No.: 14/376,876

(22) PCT Filed: Feb. 22, 2013
(86) PCT No.: PCT/SE2013/050154

§ 371 Date: Aug. 6, 2014

Related U.S. Application Data
(60) Provisional application No. 61/604,905, filed on Feb. 29, 2012.

(30) Foreign Application Priority Data
Feb. 23, 2012 (SE) 1250164-9

(51) Int. Cl. G06F 17/30

(52) U.S. Cl. CPC G06F 17/30023; G06F 17/30864
USPC 707/706

(57) ABSTRACT

A method for searching digital multi-media content, comprising associating at least one metadata object independently with a respective time interval of a content. Creating a record for a time interval of the content, the record containing at least one metadata object associated with the particular time interval of the content, wherein two or more metadata objects can relate to at least part the same time interval. Providing the record to a search engine, wherein the record is arranged such that searches can be performed by the search engine, potentially resulting in at least one pointer to at least one time interval of a content.

### TECHNICAL FIELD

Present invention relates to a method for searches of digital content. The invention also relates to a system for searches of digital content. The invention also relates to a computer program product for searches of digital content.

### BACKGROUND

The media landscape of today changes to a more complex nature than historically. The number of media production companies might increase, however their capture and generation of multimedia content significantly increases. Further, new devices like mobile terminals and other electronic devices capture and generate significant quantities of digital content. Prior to the digitalization of devices for consumer usage, such as digital cameras, video cameras, mobile phones, and similar electronic devices, hardly any user generated content, was published or made available to the public.

Most multimedia content of today is in digital format. Even historical content of interest is being digitalized. TV broadcasting companies and other media companies typically store content in electronic archives. The content may be intended for later publication or normal archiving.

A broadcast from, for example a sports game or a news spot, is typically built of a number of clips. Typically the clips are built of a number scenes, such as a plurality of camera shots, a number of sound tracks, or/and post process added material. For example, a clip may exceed over a hundred channels. Even a single radio news spot may include a large number of elements of content.

The basic idea with an archive is obviously to be able to find historical news, entertainment, or similar material, regardless of if it has been published or not. The finer granularity, i.e. more related information, the better chance to find relevant material. Although one challenge with finer granularity is the potential greater number of hits, at archive searches.

Content generated for sole commercial usage, for example commercials, has in principal the same needs as, for example news or entertainment material in relation to archives. But material intended for commercial usage, is sometimes planned for usage over a time period covering multi cultural and multilingual audiences, which requires flexibility in terms of content management. Yet another dimension of complexity is where non-commercial content is mixed with commercial content, or non-commercial content is mixed with different commercial content, where the different commercial content is intended for different target groups. An example may be sports event of a regional or global interest, but which includes local commercial messages and/or user generated content in local languages.

The archive solutions for digital multimedia content of today are typically created with a predefined structure, e.g. a fixed database structure for storage of content and a fixed database structure for storage of metadata. The metadata is important to be able to find content in an archive. The better metadata the higher value of a content archive. Predetermined structures for metadata allow users to automatically or manually enter data such as a location, character person in a scene, or a contextual description. There are today different systems for metadata, some are generic and some are intended for a specific kind of content such as news, sports, commercials, etc.

There are a number of problems with the technical solutions of today. For each cut of a video, a specific metadata model has to be determined. There are today no systems that can manage an infinite number of metadata models per repository and individual assets, e.g. data storage structure. Today's metadata models are, for example, either static on a per cut basis, or limited to a number pre specified number levels or steps in a hierarchy. An example is shown in FIG. 6, as an example a movie clip, with two type's metadata describing the movie. Yet another problem with today's technologies is management of different types of content, i.e. the subcomponents of content. It is not possible to do generic handling of different types of subcomponents like sound tracks, video tracks, graphics, subtitles, captions, voice owners, etc. Instead each subcomponent needs to be pre defined and it needs it own structure.

The above described limitations and other limitations, prevents growths of and quality of metadata. That in turn leads to limitation of the value of the metadata. It becomes difficult to find archived content, and traceability becomes limited. New technologies for media capture, for example cameras, will in the future generate an increasing amount of metadata. Another factor that will drive the increase of metadata is the editing process, where metadata is added to content in a stage after a capture. Another example of a problem today is that users of a search system will either not find content searched for, or receive too many hits in a search. Too many hits will require a long time to analyze, and an increasing risk of missing interesting content or content searched for.

The limitations of existing technologies for searches of digital multimedia content, will become larger in the future with larger amounts of content as well as larger amounts metadata, and further varied content types and types of generated metadata.

### SUMMARY

It is an object of the invention to address at least some of the problems and issues outlined above. It is possible to achieve these objects and others by using a method and a system as defined in the attached independent claims.

According to an aspect, a method is provided for searching digital multimedia content. By associating at least one metadata object independently with a respective time interval of a content, and creating a record for a time interval of the content, the record containing at least one metadata object associated with the particular time interval of the content, two or more metadata objects can at least relate to part of same time interval. The method further includes providing the record to a search engine, and the record is arranged such that searches can be performed by the search engine, potentially resulting in at least one pointer to at least one time interval of a content.

An advantage with two or more metadata objects at least partially related to the same object, is that searches are possible to perform and find only the common or combined part of an object. Further by the creation of a record of metadata objects related to a time interval, and by provision of the record to a search engine it may be possible to find objects searched for in large databases of digital content.

According to another aspect, a system is provided for searches of digital multimedia content The system comprises means for association of at least one metadata object independently with a respectively time interval of a content. The system further includes means for creation of a record for a time interval of the content, where the record contains at least one metadata object related to the particular time interval of the content. Two or more metadata objects can at least partially relate to the same time interval. The system further includes means for provision of the record to a search engine, with the record arranged such that searches can be performed by the search engine, that potentially results in at least one pointer to at least one time interval of a content.

The above method and apparatus may be configured and implemented according to different optional embodiments. In one possible embodiment of the solution, it may include the steps of storing the content in a first database and storing the metadata object in a second database. The solution may in an embodiment further include any steps of associating at least one metadata object independently with a respectively time interval of at least a component of a content, or associating at least one metadata object independently with another metadata object. The solution may in an embodiment further include converting content from a first media format to a second media format at storage in the first database, or at retrieval from the first database. In an embodiment is a metadata object time marked and/or version marked.

Further possible features and benefits of this solution will become apparent from the detailed description below.

### BRIEF DESCRIPTION OF THE DRAWINGS

Method steps and units appearing in multiple figures have the same references in the different figures.

The invention will now be described in more detail by means of exemplary embodiments and with reference to the accompanying drawings, in which:

FIG. 1 shows an overview of elements in a system.

FIG. 2a shows a flowchart for content search.

FIG. 2b shows a flowchart of an embodiment for content search.

FIG. 3 is a schematic view of content and metadata object.

FIG. 4 is a schematic view of an embodiment of content and metadata object.

FIG. 5 is a block diagram illustrating units in a system for content search.

FIG. 6 shows a data structure according to prior art.

### DESCRIPTION

Present solution relates to a method and a system for searches of digital content, in particular a broad scope of multimedia content, including but not limited to video, pictures, graphics, voice, music, general sound, and similar formats. When performing searches for information in text documents, there are today methods and tools for effective search. One reason for that, is the fact that text documents are easily readable by a machine. However, when a content is not directly readable by a machine, searchability becomes dependent on metadata. If one makes the comparison with the old photo archive with old days news papers, the archive was totally dependent on how well it was structured and how well the photos where described. With present terminology this could be expressed as metadata and structures thereof. This applies to also today's archives for digital multimedia content.

It is an objective of the present solution to enable searches of content and metadata, and as results receive relevant content. And only relevant content searched for.

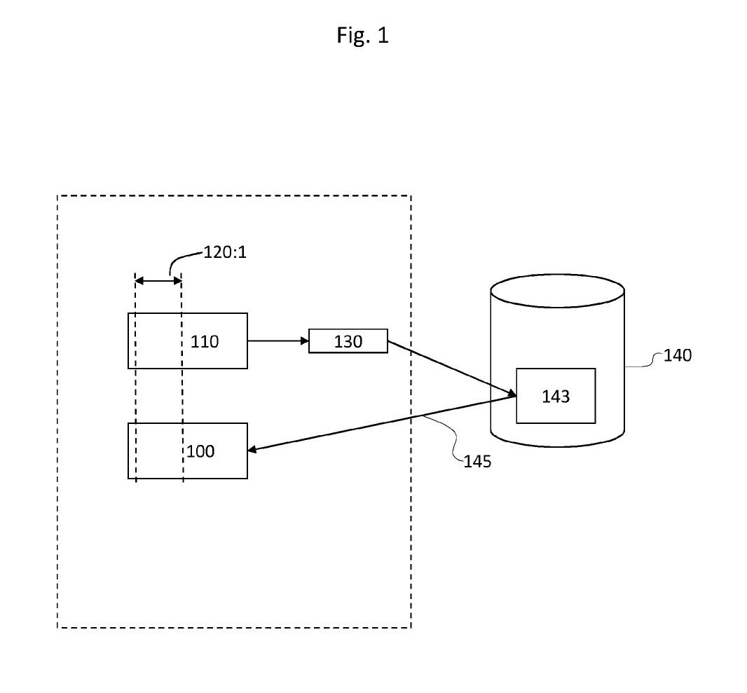

FIG. 1 shows and overview of some elements in a method, system and a computer program for searches of digital multimedia content 100. The figure also shows a metadata object 110. Further is a time interval 120 with a start and stop shown, followed by a record 130 and a search engine 140, with an index 143 and a pointer 145.

Digital multimedia content 100 is hereinafter referred to as content 100, and content 100 may in a broad scope include any general content in digital format. Examples of such content are: movies, multimedia, sounds, graphics, texts, not limiting content to other types of content. A description of metadata is information about information. As mentioned above, a video or a photo may not be directly readable by a machine. Therefore some information about a video or a photo may facilitate to find, for example, a desired video or a part of a video. According to the figure, a content 100 is associated with a metadata object 110 through a time interval 120. Of the metadata object 110 associated with the time interval 120 of the content 100, a record 130 is created. A record 130 is advantageous for a search engine 140, performing searches. As an example a record 130 may be used for generation of an index, such as the index 143 shown in FIG. 1. When the search engine 140 performs a search, a result may be generated as pointer to a content 100. The pointer indicating a content 100, or a part of content 100 that coincidences with a metadata object 110, descriptive for the content 100.

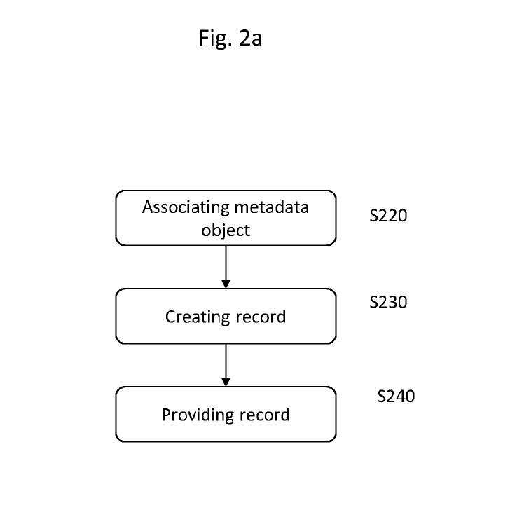

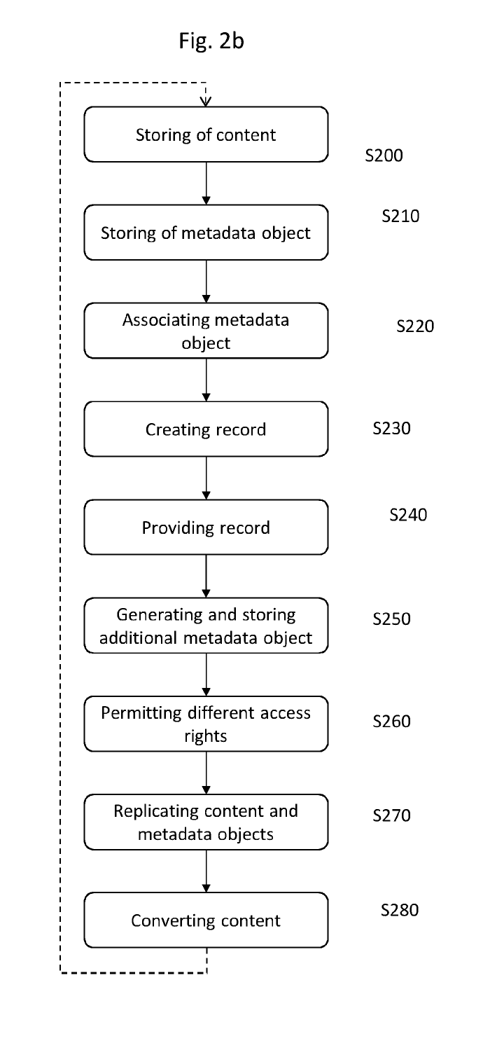

FIG. 2a shows a flowchart illustrating an embodiment of a method for searching multimedia content 100.

According to FIG. 2a the first step S220 in the flowchart, the method comprises associating a metadata object 110 with a respectively time interval 120 of a content 100. A content 100 may be any type of digital content. According to an embodiment content 100 may be at least one, or a plurality of pictures, video, still or moving graphics, different kind of sounds like voice, music, effects, overdubs, or documents such as plain text or rich text formats. A metadata object 110 may refer to another metadata object 110. A metadata object 110 may also be a descriptive information. Such descriptive information may include a specification and the information itself. An example is specification: “title” with the information “Playing kids”. Other examples may include: location and other geographical information, participants, production ids, camera angles, weather conditions, scenes, authors, date, codecs, type, id, remark, relationship, type of relationship, flags, class, status. These examples are not limiting other types of metadata. According to an embodiment, a time interval 120 is a time period with a defined start time and a stop time. The start and stop time may, for example, be an absolute time, or a time relative to the start of the duration of the digital content, represented in seconds or samples.

A defined start time and stop time, is advantageous for facilitation of an association between a content 100 and a metadata object 110. The time interval 120 advantageously defines the part of a content 100, which the metadata object 110 relates to.

The method further in step S230 comprises creating a record 130 for a time interval 120. According to an embodiment, the record 130 contains at least one metadata object 110. The record 130 relates to a specific content 100. The record 130 may be in different formats. In an embodiment the record 130 may be in xml-format. Other examples of formats are: plain text, html, pdf, ascii rich text formats, or spreadsheet formats.

In step S240 the method comprises providing the record 130 to a search engine 140. In an embodiment the record 130 is arranged such that searches can be performed by a search engine 140, and potentially resulting in at least one pointer 145, to at least one time interval 120 of a content 100. How a search engine works in detail is not described herein, because it is not in the scope of the invention. However the record 130 may for example be used as for generation of an index 143.

A record 130 is advantageous for a search engine 140, and for generation of an index 143. Thereby the search engine becomes independent of any metadata structure, an unlimited to size and classification of metadata.

FIG. 2b shows a flowchart of another embodiment of method for searching multimedia content 100. The method according to FIG. 2b may include the steps shown in FIG. 2a.

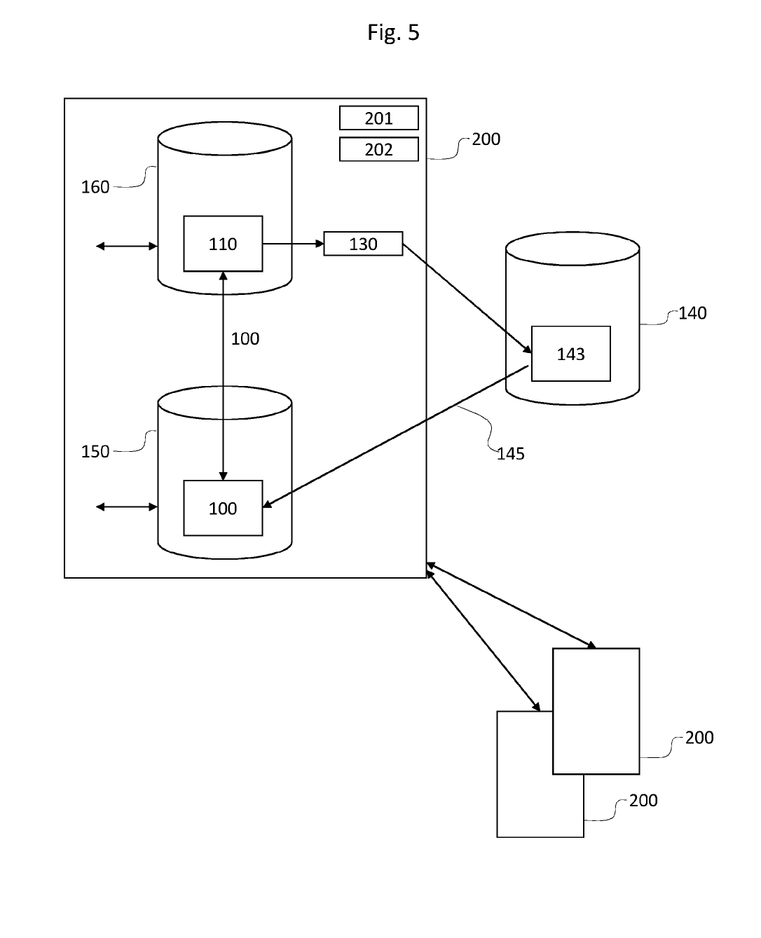

Step S200 comprises storing of content 100. Storage of content is further described in FIG. 5. The content 100 may be received from a camera, microphone, or other capturing device. The content 100 may as well, for example, be post processed or recorded for archive purposes. Before storing of content 100, it may be converted from one format to another format (not shown in the figure)

Step S210 comprises storing of metadata object 110. Metadata object 110 may be received in parallel with content 100, or received separately. Metadata 110 may be received in principal simultaneously with content 100, or at another occasion.

Step S220 to step S240 is in principal identical with the steps shown in FIG. 2a.

Step S250 comprises generating and storing of additional metadata object or objects 110. In an embodiment it is possible to further add metadata object or objects 110. Such metadata objects 110 may include information added by manual entry of information by an operator. Such metadata objects 110 may also be entered by a machine. Metadata objects 110 may be captured from content 100 through analysis.

Step S260 comprises permitting different access rights. Different access rights may provide different users of a method for searching multimedia content 100, limited access to content 100, or selective access to content 100. Such an access right my for example be determined by the type of content 100, the type of metadata 110, by whom content 100 or metadata 110 is originating from. Or from which machine or automatic process content 100 or metadata 110 is originating.

Differentiated access right is advantageous for enablement of permission to content to users with different roles. Different roles may be people with different work tasks. Different roles may also be different organizations, such is different companies or different audiences.

Step S270 comprises replicating content 100 and/or metadata object 110. A small installation of a system performing the steps in a method for searching multimedia content 100, may only include a single physical unit. A larger installation may include a plurality of physical unit located together. Optionally the method is carried out on units distributed throughout a network. With the units physically distanced. Some units may be always connected to a network, and some units may be both online as well as offline.

Step S280 comprises converting content 100. In an embodiment content 100 may be converted from one format to another format when retrieved from a database (database further described in FIG. 5). If for example content 100 is stored in an original format, it may be suitable to convert content 100 to a format that may be adapted for a editing device, distribution format, playout device or similar. An example may be conversion of a high definition format media to a media adapted for a mobile device.

The steps described in FIG. 2b, may be performed in different orders, than shown in the figure, according to various embodiments. Further may some of the steps be omitted, which may depend on preferred usage of the solution.

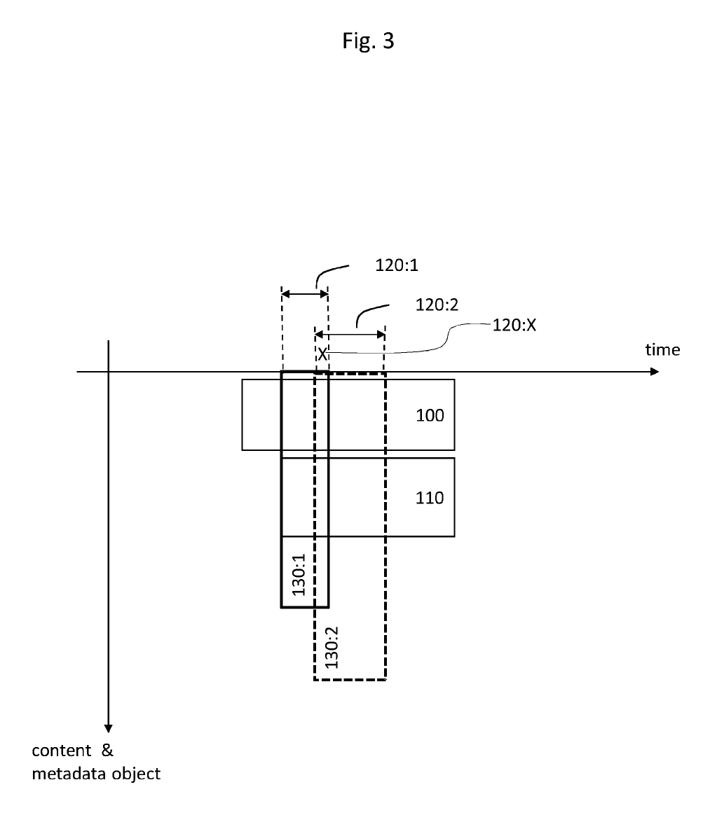

In FIG. 3 content 100 and metadata 110 is shown. Additionally an axis representing time and an axis representing content 100 and metadata 110.

According to FIG. 3, a content 100 extends along the time axis. Further a metadata object 110 extends along the time axis. The metadata object 110 start time point and stop time point may coincidence with the content 100, but the metadata object 110 may as well have a different start and stop time points relative to content 100. The content 100 and the metadata object 110 are associated with a time interval 120, according to FIG. 3. The time interval 120 is defined by a start point and a stop point. In an embodiment, not shown in the figure, the time interval 120 is infinite. A time interval 120 may be infinite when a content 100 is exemplified by a picture, a graphical picture, a generic file, or other non motional digital content 100. An example is, in a case where the start and stop time is undetermined. As shown in the figure, a record 130 is determined by the time interval 120. The record 130 contain at least one metadata object 110 associated with the content 100.

In an embodiment (not shown in the figure), another record 130 may be determined by a different time interval 120 than the first mentioned record 130. E.g. a plurality of records 130 does not have come in line as a chain, with a subsequent record 130 start where a previous record 130 stop.

However as shown in FIG. 3, a record 130:1 may be determined by a first time interval 120:1 and another record 130:2 may be determined by a second time interval 120:2. The second time interval 120:2 may overlap the first mentioned time interval 120:1. An effect of such overlap is that each record 130, defined by each time interval 120, will contain at least one metadata object 110, associated with the metadata objects 110 respective content 100. The overlap formed by the both records, may collectively point to a time interval 120:X of content 100 only covered by the both records 130:1 and 130:2.

Two or more metadata objects 110 that overlap each other is advantageous, because in may enable a user to find content 100 that is only related to the at least both metadata objects 110.

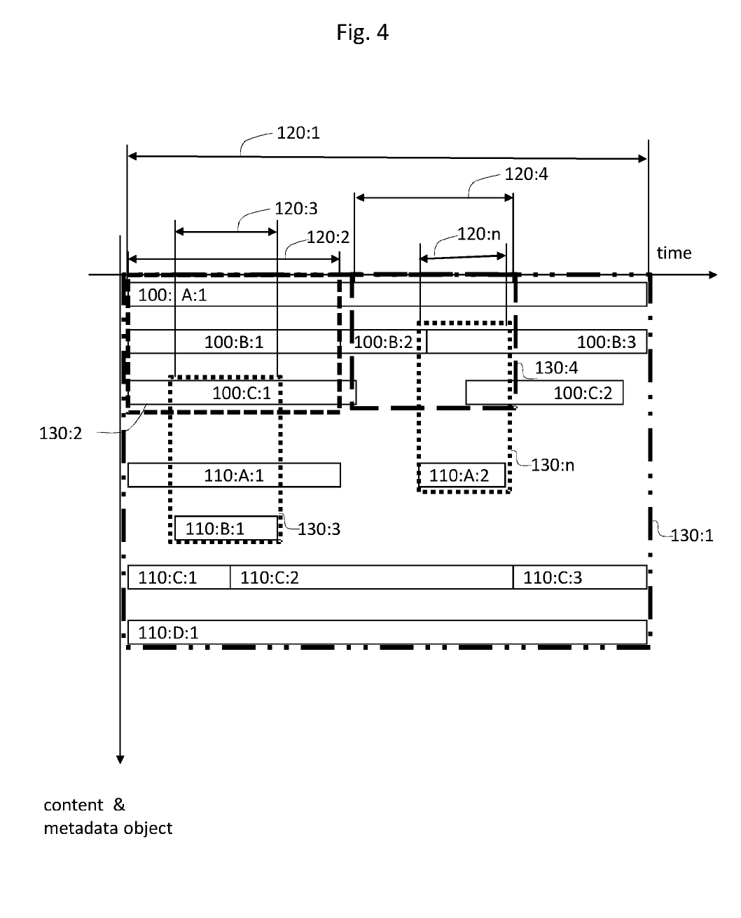

FIG. 4 shows an embodiment of contents 100 and metadata objects 110 that extend along a time axis and are distributed along the other axis. This figure shows pluralities of content 100, metadata 110, time intervals 120, and records 130.

FIG. 4 shows a plurality of content 100 (100:A, 100:B, 100:C, and so on). Various elements of content 100 that forms, for example, a complete digital multimedia content 100, such as a complete movie, may also be referred to as components, or tracks. Each component may comprise various video, sound, graphics, subtitles, name of speaker voice, animations, etc. A component of content 100 may extend through an entire duration of a content 100, exemplified by content 100:A:1. Content 100 may also be formed by a number of components in a series, shown as content 100:B:1, content 100:B:2, and content 100:B:3. Another example is content 100 formed by components of content 100:C1 and 100:C:2. In yet another example, as shown in FIG. 4, a number of tracks of components of content 100:A:1-100:C:2 collectively form content 100. An example is a news spot, with a number of video elements from a studio and various different scenes, accompanied by voices, sounds, recordings, music, graphics, and other related content. Another example is a broadcast of a football game, where a number of cameras may record the game from different views and angels, accompanied with sound recordings from microphones, speaker voices, commentator voices, graphics, and other multimedia related to the game. Other example may be a list or a log from movie production with multiple revisions and version including metadata around decisions, cuts, dialogues, scripts, rights, etc.

According to FIG. 4 metadata object 110 is structured in a similar manner as content 100. A metadata object 110 may extend along the time axis. Metadata object 110 may have an in principal direct relation with a content 100, for example a camera position, angle, or a capture time and date. An example of such direct related metadata objects 110 are metadata object 110:A:1 and 110:A:2. Another example of a metadata object 110, may be main character, or a specific environment, appearing in a certain time interval 120 of a content 100. An example, according to FIG. 4, metadata object 110:B:1 is determined by the time interval 120:3 and associated with the content 100:C:1. Yet another example of metadata object 110 is a metadata object 110 that extends along with a full time interval 120 of a content 100. An example is a same type of metadata object 110:C:1, 110:C:2, 110:C:3, such as the name of respective studio person 1, 2 and 3 throughout a news spot. Yet another example of a metadata object 110, is a metadata object 110:D:1 which, according to the figure extends along with an entire time interval 120 of a content 100. An example of a metadata object 110:D:1 may be a title, a description, author, free text information, comments, GPS coordinates, quality check information or other information relevant to an content 100 not partial limited by a time interval 120.

Metadata objects 110 that may be defined unlimited of any predefined structure is advantageous because it permits entry of new meta data types, potentially not originally thought of. Further metadata objects 110 according to the above described structure, is advantageous because permit associations unlimited to any pre determined structure. It allows for multiple, disparate and individually unrelated structures on the same content and asset.

FIG. 5 shows a view of a system comprising a first database 150 for storage of content 100, a second database 160 for storage of metadata objects 110. The first and second databases 150, 160 arranged in a node 200. The node 200 also including a processing unit 201 and a memory unit 202. A search engine 140 that can use an index 143, is also shown in the figure.

According to FIG. 5 the first database 150 has an interface for reception of content 100 and retrieval of content 100. The first database 150 also has in interface for communication with the second database 160. Associations between content 100 and metadata 110 may be performed over the interface between the first and second database 150, 160. At storage of content 100 a conversion may be performed from one format to another format of content 100. Conversion may also be performed at retrieval of content 100 from the first database 150, conversion from one format to another format. Although the first database 150 may handle various formats of content 100, and is therefore not bound by any specified formats.

In FIG. 5 is further the second database 160 for metadata object 110 storage, shown. The second database 160 has an interface for reception and retrieval of metadata objects 110. That interface may receive metadata objects 110 generated by machine, or entered by an operator. Metadata objects 110 may be received and stored in the second database 160 unlimited subsequently. The interfaces on the databases, for reception and retrieval, may also be suitable for other systems that perform post analysis of content 100 or metadata objects 110. Example of such systems for post processing may be face recognition, voice recognition, technical quality data, rights management, automatic trimming, any kind of rules based automatic editing, etc.

As shown in FIG. 5, the record 130 is created in the second database 160. The record 130 is either transmitted to a search engine 140, or retrieved by the search engine 140. The search engine 140 itself is outside the scope of this solution. However typically a search engine 140 uses a record 130 for generation of an index 143. And in this solution an index 143 may be used by a search engine 140, for generation of potentially at least one pointer to a content 100, in the first database 150. That may be the case when a search for digital multimedia content is performed, by use of a single, or a plurality of search terms, collectively or combined in a certain way. Such a search may match with metadata objects 110 associated with time intervals 120 of content 100, and thereby provide a desired search result.

The figure shows a couple of additional nodes 200. In a large system solution, a plurality of nodes 200 may serve users with the same or similar functionality, as a single node. It may as well be the case that different nodes 200 may contain different functionality and therefore carry out different functionalities, or partially different functionalities. How to architect and set up computers and communications networks for a solution, is known to the person skilled in the art. It is therefore understood that there are a number of variants of how to set up a system, not limited by above described examples.

Replication may be advantageous in a large scale system. Replication also may be advantageous in a distributed system where users are located over distances. Replication may also be advantageous when a users may be partly off-line and partly on-line, and thereby having access to content even when off-line.

In an embodiment, the node 200 comprises a processing unit 201 for execution of instructions of computer program software, according to FIG. 5. The figure further shows a memory unit 202 for storage of a computer program software and cooperation with the processing unit 201. Such processing unit 201 and memory unit 202 may be provided by a general purpose computer, or a computer dedicated for multimedia content searches.

In an embodiment, not shown in figures, content 100 may be user generated content. Such content may not technically be different from other content. The difference may rather be seen from a scale and device perspective. As an example public TV, buys a production from a production company showing a football event, and broadcasts it to its TV audience. However the live watching audience on an arena, may use their electronic devices, for captures of the game. An audience may range from a few people watching the local school game, to a major event with tens of thousands of people present. A few examples of electric devices used, may be mobile phones, pda's, video cameras, and similar. user generated content may be stored as content 100 in a first database 150, and metadata object 110 may be stored in a second database 160. And thereafter be treated in similar way as above described content 100 and metadata object 110 according to FIGS. 1 to 5.

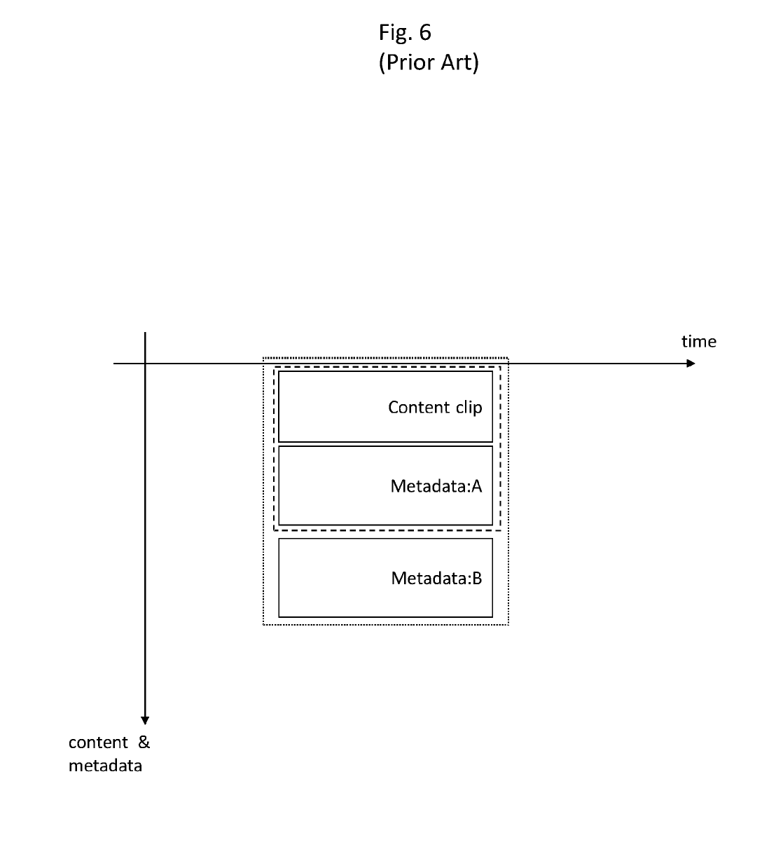

It should be noted that FIG. 6 illustrates various functional units in the node 200 and the skilled person is able to implement these functional units in practice using suitable software and hardware means. Thus, this aspect of the solution is generally not limited to the shown structures of node 200, and the databases 150, 160 may be configured to operate according to any of the features described in this disclosure, where appropriate.

1. A method for searching digital multimedia content, the method comprising:
associating at least one metadata object, independently, with a respective time interval of a content;
creating a record for a time interval of the content, the record containing at least one metadata object associated with the particular time interval of the content, wherein two or more metadata objects can relate to at least part of the same time interval;
providing the record to a search engine;
wherein the record is arranged such that searches can be performed by the search engine, potentially resulting in at least one pointer to at least one time interval of a content.

2. The method according to claim 1, wherein the method comprises:
storing of the content in a first database.

3. The method according to claim 1, wherein the method comprises:
storing of the metadata object in a second database.

4. The method according to claim 1, wherein the method comprises:
associating at least one metadata object, independently, with a respectively time interval of at least a component of a content.

5. The method according to claim 1, wherein the method comprises:
associating at least one metadata object, independently, with another metadata object.

6. The method according to claim 1, wherein the method comprises:
generating and storing of additional metadata objects at a subsequent stage in time, which can be performed by different user roles.

7. The method according to claim 1, wherein the method comprises:
permitting different user roles, different access rights to metadata objects and contents.

8. The method according to claim 1, wherein the method comprises:
replicating contents and metadata objects between a plurality of nodes.

9. The method according to claim 1, wherein the method comprises:
converting content from a first media format to a second media format at storage in the first database, or at retrieval from the first database.

10. A system for searches of digital multimedia content, the system comprising:
means for association of at least one metadata object, independently, with a respective time interval of a content;
means for creation of a record for a time interval of the content, the record containing at least one metadata object associated with the particular time interval of the content, wherein two or more metadata objects can relate to at least part of the same time interval;
means for provision of the record to a search engine;
wherein the record is arranged such that searches can be performed by the search engine, that potentially results in at least one pointer to at least one time interval of a content.

11. The system according to claim 10, the system comprising:
means for association of at least one metadata object, independently, with a respective time interval of at least a component of a content.

12. The system according to claim 10, the system comprising:
means for association of at least one metadata object, independently, with another metadata object.

13. The system according to claim 10, the system comprising:
means for storage of the content in a first database.

14. The system according to claim 10, the system comprising:
means for storage of the metadata object in a second database.

15. The system according to claim 10, the system comprising:
means for generation and storage of additional metadata objects at a subsequent stage, which can be performed by different user roles.

16. The system according to claim 10, the system comprising:
means for determination of permission to different user roles, different access rights to metadata objects and contents.

17. The system according to claim 10, the system comprising:
means for replication of contents and metadata objects between a plurality of nodes.

18. The system according to claim 10, the system comprising:
means for conversion of content from a first media format to a second media format at storage in the first database, or at retrieval from the first database.

19. The system according to claim 10, the system wherein:
a metadata object is in a value or reference format.

20. The system according to claim 10, the system wherein:
a metadata object is time marked and/or version marked.

21. A non-transitory computer readable medium storing computer readable code that when run in a system for searches of digital multimedia content causes the system for searches of digital multimedia content to perform the method according to claim 1.

22. (canceled)
